(19) United States
(12) Patent Application Publication
(10) Pub. No.: US 2011/0310231 A1
(43) Pub. Date: Dec. 22, 2011

(54) STEREOSCOPIC IMAGING OPTICAL SYSTEM, INTERCHANGEABLE LENS APPARATUS, AND CAMERA SYSTEM

(75) Inventors: Shinji Yamaguchi, Osaka (JP); Michihiro Yamagata, Osaka (JP)

(73) Assignee: Panasonic Corporation, Osaka (JP)

(21) Appl. No.: 13/160,525

(22) Filed: Jun. 15, 2011

(30) Foreign Application Priority Data
Jun. 16, 2010 (JP) 2010-137685

(51) Int. Cl. H04N 13/02; G02B 27/22

(52) U.S. Cl. 348/49; 359/464; 348/E13.074

(57) ABSTRACT

A stereoscopic imaging optical system is provided, which forms two optical images having no mutual interference, side-by-side, on a rectangle image sensor, and which is applicable to an interchangeable-lens type digital camera system. The stereoscopic imaging optical system includes a first lens system and a second lens system which are arranged in parallel, and a field diaphragm arranged on the object side relative to these lens systems. The first lens system and the second lens system form optical images of an object on a first imaging area and a second imaging area, respectively. The field diaphragm has an aperture arranged in front of the first lens system and the second lens system. The field diaphragm blocks only a portion of a light beam incident on the first lens system, which portion enters the second imaging area, and blocks only a portion of a light beam incident on the second lens system, which portion enters the first imaging area.

### CROSS REFERENCE TO RELATED APPLICATION

The disclosure of Japanese Patent Application No. 2010-137685, filed on Jun. 16, 2010, is incorporated herein by reference.

### BACKGROUND OF THE INVENTION

1. Field of the Invention

The present invention relates to a stereoscopic imaging optical system used for taking a three-dimensional image, and an interchangeable lens apparatus and a camera system which employ the stereoscopic imaging optical system.

2. Description of the Background Art

In recent years, display devices capable of displaying three-dimensional images have received attentions. Several methods for creating three-dimensional images, which are based on different principles, have been known. Among them, a method of presenting images having a parallax to right and left eyes of a viewer to let the viewer perceive a stereoscopic image has become mainstream. Images for creating a three-dimensional image are taken by using an optical system which can simultaneously form a pair of images having a parallax between right and left viewpoints (refer to US Patent Application Publication No. 2004/0114231 and U.S. Pat. No. 6,269,223, for example)

US Patent Application Publication No. 2004/0114231 discloses an optical system in which two images having a parallax are projected side-by-side on a film surface by using a pair of image forming lenses and a plurality of mirrors.

U.S. Pat. No. 6,269,223 discloses a camera which can take both a two-dimensional image and a three-dimensional image by changing the positions of a pair of lenses and a plurality of mirrors.

In addition, Japanese Laid-Open Patent Publication No. 2000-338412, Japanese Patent No. 2627598, and Japanese Laid-Open Utility-Model Publication No. 51-163940 are related to the present application.

In the optical system disclosed in US Patent Application Publication No. 2004/0114231, right and left images are transposed using a plurality of mirrors to enable a viewer to stereoscopically view a photograph obtained after film development. However, the use of the plurality of mirrors complicates the configuration of the optical system, and increases the size of the optical system. Further, when a pair of lenses are arranged in parallel to each other as in this prior art document, a problem arises that images formed by the respective lenses interfere with each other.

In the camera disclosed in U.S. Pat. No. 6,269,223, when taking parallax images, interference between the images formed by the pair of lenses is prevented by using a movable partition provided in the camera. Such a partition is applicable to a lens-integrated type camera, but is difficult to be applied to an interchangeable-lens type digital camera system which is recently popular. The reason is as follows. A low-pass filter, a hand blurring compensation mechanism, a dust removal mechanism and the like are provided in the vicinity of an image sensor in the body of the interchangeable-lens type digital camera, and therefore, an additional space for a structure such as a partition cannot be secured.

### SUMMARY OF THE INVENTION

Therefore, an object of the present invention is to provide: a stereoscopic imaging optical system in which two optical images having no interference with each other can be formed side-by-side on a rectangle image sensor, and which is applicable to an interchangeable-lens type digital camera system; and an interchangeable lens apparatus and a camera system, which are equipped with the stereoscopic imaging optical system.

The present invention relates to a stereoscopic imaging optical system for forming optical images of an object on first and second imaging areas, respectively. The stereoscopic imaging optical system includes: a first lens system for forming an optical image of the object on the first imaging area; a second lens system for forming an optical image of the object on the second imaging area, the second lens system being arranged in parallel to the first lens system; and a field diaphragm arranged on the object side relative to the first and second lens systems. The first and second lens systems are arranged in such a positional relation that an image circle formed by each of the first and second lens systems is overlapped with both the first and second imaging areas. The field diaphragm does not block a light beam which enters an area on the opposite side to the second imaging area with respect to the first imaging area, and a light beam which enters an area on the opposite side to the first imaging area with respect to the second imaging area, but blocks a light beam which enters the second imaging area from the first lens system, and a light beam which enters the first imaging area from the second lens system.

The present invention relates to an interchangeable lens apparatus which is detachably attached to a camera body equipped with an image sensor. The interchangeable lens apparatus includes: a stereoscopic imaging optical system according to claim 1; and a lens mount section which is connectable to a camera mount section of the camera body.

According to the present invention, the field diaphragm prevents interference between a pair of images formed on the image sensor. Since the field diaphragm is arranged on the object side relative to the first and second lens systems, the stereoscopic imaging optical system of the present invention is readily applicable to an interchangeable-lens type digital camera system.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a cross-sectional view of an interchangeable lens apparatus having a stereoscopic imaging optical system of the present invention;

FIG. 2 is a front view of the stereoscopic imaging optical system of the present invention;

FIG. 3 is a reference diagram illustrating optical images which are formed on an image sensor by a stereoscopic imaging optical system having no field diaphragm;

FIG. 4 is a ray diagram of the stereoscopic imaging optical system of the present invention;

FIG. 5 is a diagram illustrating optical images which are formed on an image sensor by the stereoscopic imaging optical system of the present invention;

FIG. 6 illustrates a configuration diagram and an aberration diagram of a lens system according to Embodiment 1 (Example 1);

FIG. 7 illustrates a configuration diagram and an aberration diagram of a lens system according to Embodiment 2 (Example 2);

FIG. 8 illustrates a configuration diagram and an aberration diagram of a lens system according to Embodiment 3 (Example 3);

FIG. 9 illustrates a configuration diagram and an aberration diagram of a lens system according to Embodiment 4 (Example 4); and

FIG. 10 is a schematic diagram of an interchangeable-lens type camera system according to Embodiment 5.

### DESCRIPTION OF THE PREFERRED EMBODIMENTS

### Embodiment 1

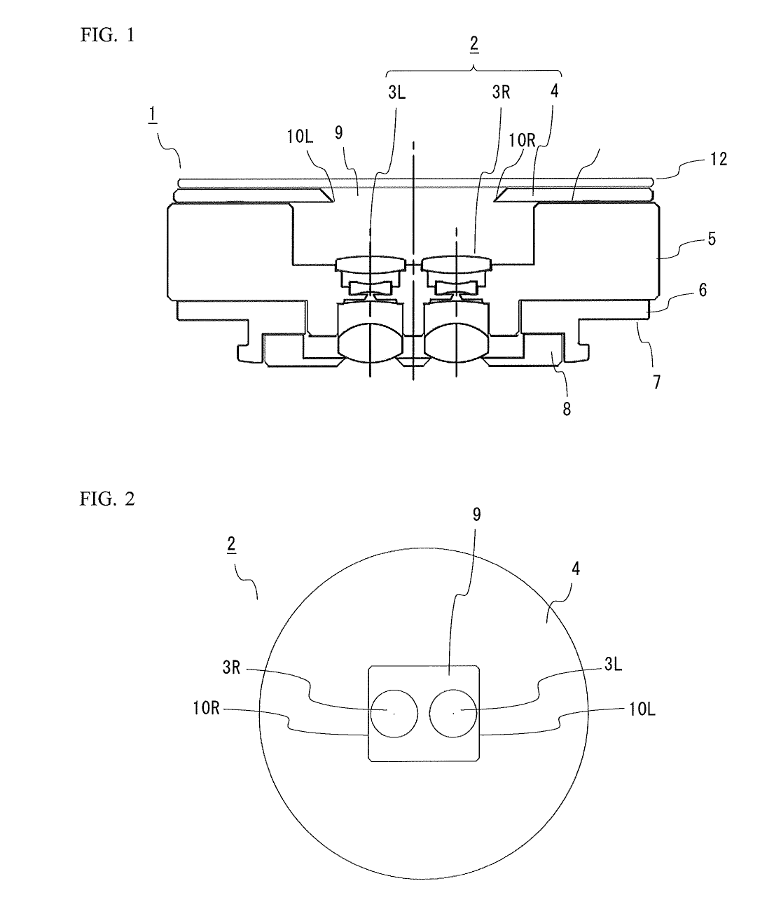

FIG. 1 is a cross-sectional view of an interchangeable lens apparatus having a stereoscopic imaging optical system of the present invention. FIG. 2 is a front view of the stereoscopic imaging optical system of the present invention.

The interchangeable lens apparatus 1 is detachably attached to a camera body of an interchangeable-lens type digital camera system, and is used to take images having an angular difference for creating a three-dimensional image (including both a still image and a moving image). The interchangeable lens apparatus 1 includes the stereoscopic imaging optical system 2, a lens barrel 5, a lens mount section 6 which is detachably connected to a camera mount section of a camera body, a protection member 8, and a glass plate 12 arranged on the most front end of the apparatus 1. The lens mount section 6 has a mount surface 7 which contacts the camera mount section in a plane-to-plane manner.

The stereoscopic imaging optical system 2 includes a pair of lens systems 3R and 3L, and a field diaphragm 4 arranged on the object side relative to the lens systems 3R and 3L.

The lens systems 3R and 3L have the same lens configuration, and are arranged in parallel so that the optical axes thereof are parallel to each other. The lens systems 3R and 3L are aligned in the horizontal direction of the camera body (the longitudinal direction of the image sensor) when the interchangeable lens apparatus 1 is attached to the camera body. The lens system 3R forms an optical image of an object on a right-half imaging area of the image sensor, and the lens system 3L forms an optical image of the object on a left-half imaging area of the image sensor. The interval between the optical axes of the lens systems 3R and 3L is set so that a predetermined parallax is generated between the right and left taken images. The lens systems 3R and 3L and the image sensor are arranged in such a positional relation that an image circle formed on the image sensor by the lens system 3R and an image circle formed on the image sensor by the lens system 3L are overlapped with each other at the center portion of the image sensor.

Each of the lens systems 3R and 3L is composed of a plurality of lens elements. Some of the lens elements are arranged so as to protrude from the mount surface 7 of the lens mount section 6 toward the image side. A lens element protruding from the mount surface toward the image side means at least a portion of the lens element being positioned on the image side relative to the plane including the mount surface. In the example of FIG. 1, a total of four lens elements, which are positioned closest to the image side in the lens systems 3R and 3L, protrude from the mount surface 7 toward the image side. The lens configuration of the lens systems 3R and 3L will be described in detail later.

By arranging the lens elements so as to protrude from the mount surface toward the image side, an aperture diaphragm in the lens optical system can be moved toward the object side relative to the lens principal point. In addition, stray light, which enters from the object side relative to the aperture diaphragm, can be blocked by a portion of the lens barrel that holds the lens elements protruding from the mount surface 7.

The field diaphragm 4 is composed of a member having a single aperture 9. The aperture 9 is positioned on the object side relative to the lens systems 3R and 3L. The aperture 9 has, at a part of a circumferential edge constituting the aperture, a pair of linear edges 10R and 10L which extend in the same direction (the vertical direction in FIG. 2) as a center line that divides the imaging surface of the image sensor to right and left parts. A portion of a light beam incident on the center portion of the image sensor is blocked by the edges 10R and 10L. The blocking of the incident light by the field diaphragm 4 will be described in detail later.

The lens barrel 5 is approximately cylindrical in shape, and holds the lens systems 3R and 3L by its center portion. The field diaphragm 4 is attached to the front face of the lens barrel 5, and the lens mount section 6 is provided on the rear face of the lens barrel 5. The protection member 8 is provided to protect the lens elements which protrude from the mount surface 7 of the lens mount section 6 toward the image side. The glass plate 12 on the most front face is provided to protect the lens systems 3R and 3L and to prevent entry of dust and trash into the lens barrel 5.

The following will describe the detail of the function of the field diaphragm 4 in an exemplary case where right and left images are taken by using a single image sensor. In the following description, a right-half part and a left-half part of the imaging surface are referred to as an imaging area 11R and an imaging area 11L, respectively.

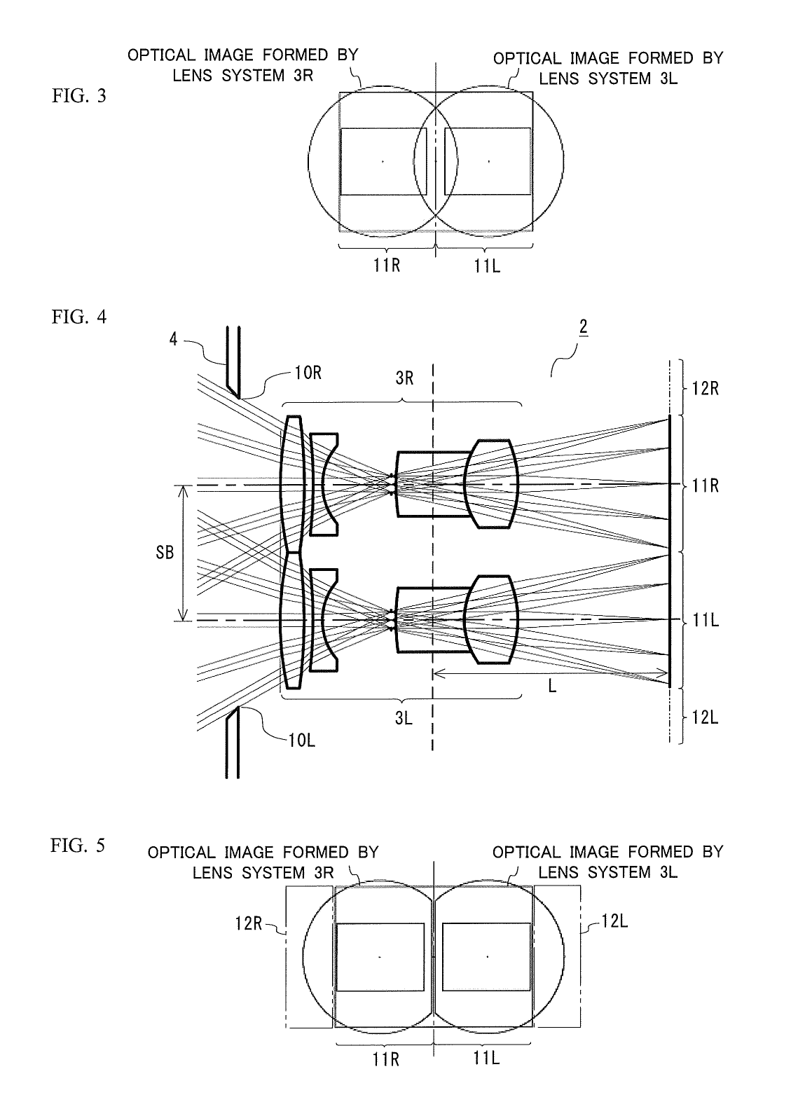

FIG. 3 is a reference diagram illustrating optical images formed on an image sensor by a stereoscopic imaging optical system having no field diaphragm.

When two images are formed side-by-side on the imaging area 11R and the imaging area 11L of the single image sensor by using only two lens systems arranged in parallel, the right and left images might be mixed at the center portion of the image sensor, or stray light from the right-side lens system might enter the left-side imaging area (or stray light from the left-side lens system might enter the right-side imaging area). In this case, it is necessary to reduce the clipping size of the right and left images.

FIG. 4 is a ray diagram of the stereoscopic imaging optical system of the present invention. FIG. 5 is a diagram illustrating optical images formed on the image sensor by the stereoscopic imaging optical system of the present invention. In FIG. 4, a dashed line represents the position of the mount surface.

As shown in FIG. 4, the stereoscopic imaging optical system of the present invention includes, on the object side relative to the pair of lens systems, the field diaphragm 4 for blocking a portion of a light beam incident on the center portion of the image sensor. On the plane including the field diaphragm 4, the light beams incident on the right and left lens systems 3R and 3L, respectively, are partially overlapped with each other. However, since the field diaphragm 4 blocks the light beam incident on the center portion of the image sensor, the light beam converged by the lens system 3R and the light beam converged by the lens system 3L are not overlapped with each other on the imaging surface. Even if the light beams are overlapped, the width of overlapping becomes minimum. More specifically, as shown in FIGS. 4 and 5, the right-side edge 10R of the flare stop 4 blocks a portion of the light beam incident on the right-side lens system 3R, which portion has an angle of incident on the left-side imaging area 11L. The left-side edge 10L of the flare stop 4 blocks a portion of the light beam incident on the left-side lens system 3L, which portion has an angle of incident on the right-side imaging area 11R. However, when the field diaphragm 4 of the present invention is used, light beams incident on a pair of regions along the short sides of the image sensor (alternate long and two short dashes lines in FIGS. 4 and 5), i.e., an area 12R on the opposite side to the imaging area 11L with respect to the imaging area 11R and an area 12L on the opposite side to the imaging area 11R with respect to the imaging area 11L, are not blocked.

According to the function of the field diaphragm 4, as shown in FIG. 5, a pair of image circles formed on the image sensor are each cut into a shape of D along the boundary between the imaging areas 11R and 11L. As a result, the optical images formed by the pair of optical systems are prevented from being mixed on the image sensor. Accordingly, when the stereoscopic imaging optical system 2 of the present invention is used, the number of pixels in the right and left images can be increased by efficiently utilizing the imaging surface of the single image sensor, with a compact and simple configuration.

It is ideal that the cutting positions (portions corresponding to the edges 10R and 10L) of the images formed on the image sensor coincide with the boundary of the imaging areas 11R and 11L (the center line shown by the alternate long and short dash line in FIG. 5). However, actually, as shown in FIGS. 4 and 5, a small portion shielded from incident light may be generated between the pair of optical images formed on the image sensor, or the pair of optical images formed on the image sensor may be slightly overlapped. In any case, the clipping size of the images from the imaging areas 11R and 11L can be sufficiently increased as compared to the reference example shown in FIG. 3.

Since the stereoscopic imaging optical system of the present invention does not require a structure such as a partition at the front face of the image sensor, it is favorably applicable to an interchangeable lens apparatus of an interchangeable-lens type camera system. Moreover, the stereoscopic imaging optical system is similarly applicable to a lens-integrated type camera system.

In the above-described example, right and left optical images are formed side-by-side on the single image sensor by using the stereoscopic imaging optical system of the present invention. However, the stereoscopic imaging optical system of the present invention may be combined with two image sensors arranged in parallel. A space may be provided between imaging areas of the two image sensors. In this case, a pair of lens systems are arranged so as to form optical images on the pair of image sensors, respectively. Also in this case, as in the above-described example, a field diaphragm, which blocks a light beam that enters the left-side imaging area from the right-side lens system and a light beam that enters the right-side imaging area from the left-side lens system, may be provided to prevent mixing of right and left optical images on the respective image sensors, or entry of stray light.

The following will describe embodiments of lens systems 3R and 3L applicable to the above-described stereoscopic imaging optical system.

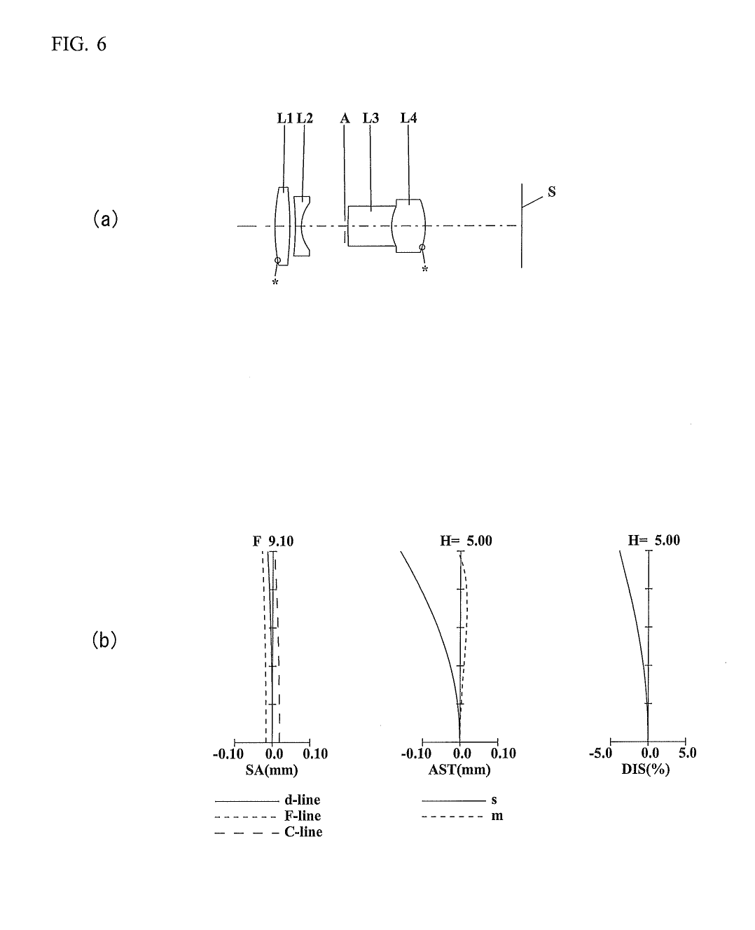

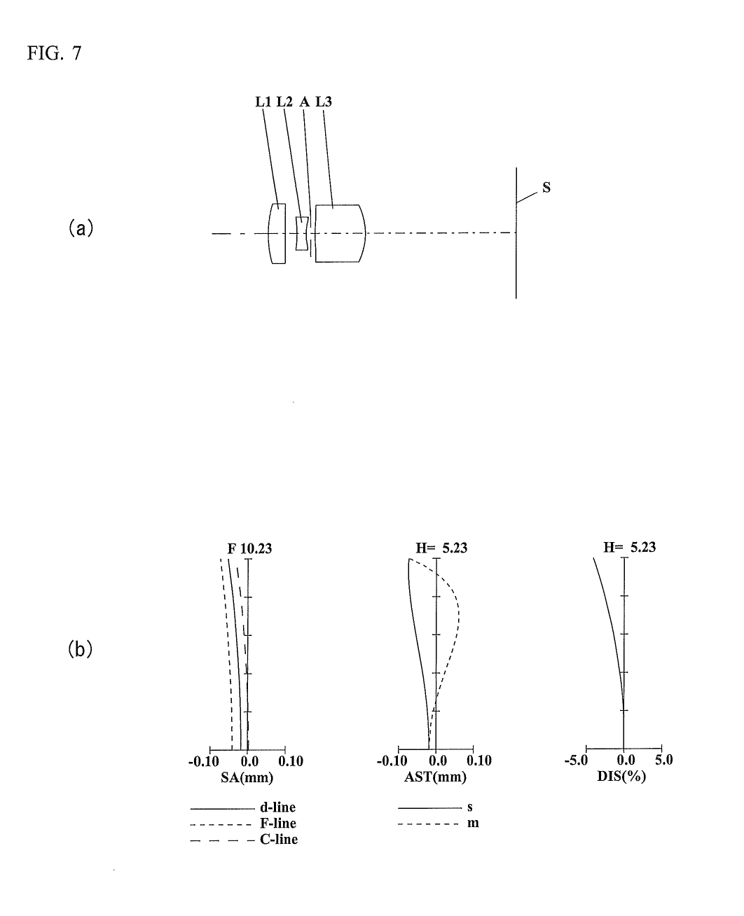

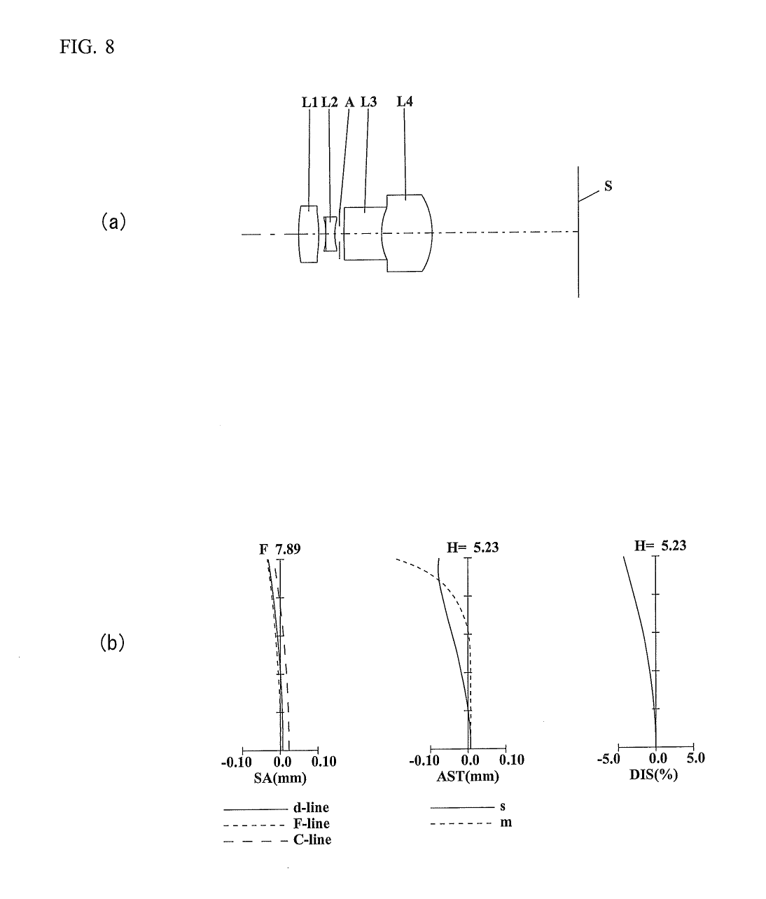

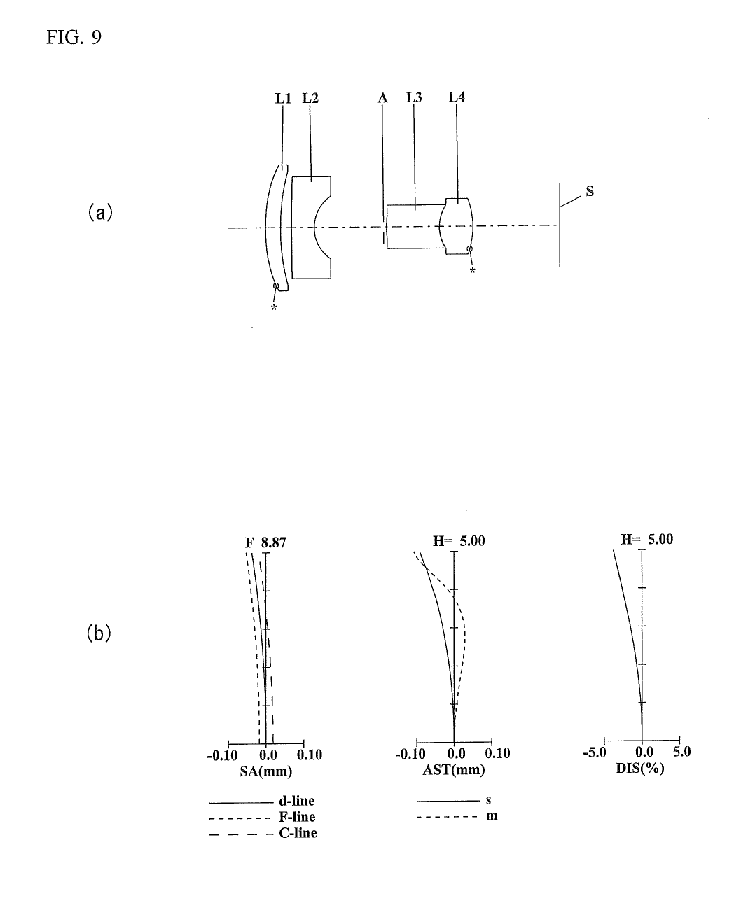

In each of FIGS. 6 to 9, section (a) shows a configuration diagram of a lens system according to each embodiment, and section (b) shows an aberration diagram of the corresponding lens system. In each configuration diagram, an asterisk * imparted to a particular surface indicates that the surface is aspheric. A straight line on the rightmost side indicates the position of an image surface S. A symbol A indicates an aperture diaphragm.

### Embodiment 1

A lens system according to Embodiment 1 comprises, in order from the object side to the image side, a bi-convex first lens element L1, a bi-concave second lens element L2, a negative meniscus third lens element L3, and a bi-convex fourth lens element L4. The first lens element L1 has an aspheric object-side surface, and the fourth lens element L4 has an aspheric image-side surface. The third lens element L3 and the fourth lens element L4 are cemented with each other.

### Embodiment 2

A lens system according to Embodiment 2 comprises, in order from the object side to the image side, a bi-convex first lens element L1, a bi-concave second lens element L2, and a bi-convex third lens element L3.

### Embodiment 3

A lens system according to Embodiment 3 comprises, in order from the object side to the image side, a bi-convex first lens element L1, a bi-concave second lens element L2, a negative meniscus third lens element L3, and a bi-convex fourth lens element L4. The third lens element L3 and the fourth lens element L4 are cemented with each other.

### Embodiment 4

A lens system according to Embodiment 4 comprises, in order from the object side to the image side, a positive meniscus first lens element L1, a negative meniscus second lens element L2, a negative meniscus third lens element L3, and a bi-convex fourth lens element L4. The first lens element L1 has an aspheric object-side surface, and the fourth lens element L4 has an aspheric image-side surface. The third lens element L3 and the fourth lens element L4 are cemented with each other.

In Embodiments 1, 3, and 4, at least the fourth lens element L4 is arranged so as to protrude from the mount surface toward the image side. Since the positive optical power of the protruding fourth lens element L4 is strong, two lens elements for each of the right and left lens systems (four lens elements in total) are provided on the image side relative to the aperture diaphragm in order to compensate chromatic aberration. In particular, the two lens elements are preferably a combination of a positive lens element and a negative lens element.

The following will describe conditions to be satisfied by the stereoscopic imaging optical system of the present invention. Here, a plurality of conditions to be satisfied are set forth. A configuration that satisfies as many conditions as possible is most desirable. However, when an individual condition is satisfied, a stereoscopic imaging optical system having the corresponding effect is obtained.

A diagonal view angle (2ω) at a wide-angle limit of the lens system of the present invention is preferably 35 degrees or more. When this condition is satisfied, a compact stereoscopic imaging optical system, which provides easy-to-use images, can be configured. Further, when the view angle is widened, the amount of defocus of an image, which is formed by a light beam passing near the edge of the field diaphragm, is reduced, and thus the number of pixels in the right and left images can be increased.

The stereoscopic imaging optical system of the present invention preferably satisfies the following condition.

0.1<T/f_{W}<15.0 (1)

where

T is a distance from the most object-side lens surface of the lens system to the field diaphragm, and

f_{W} is a focal length of the lens system at a wide-angle limit.

If the value goes below the lower limit of the condition (1), the amount of defocus of the image at the position corresponding to the edge of the field diaphragm is increased, and thus the range available for image taking on the imaging surface is reduced (the number of pixels in the taken image is reduced). If the value exceeds the upper limit of the condition (1), the distance between the lens system and the field diaphragm is excessively increased, which causes an increase in the size of the entire optical system.

The lens system of the present invention preferably satisfies the following condition.

0.3<fᵣₑₐᵣ/f_{W}<2.8 (2)

where

fᵣₑₐᵣ is a synthetic power of lens elements protruding from the mount surface toward the image side, and
f_{W} is a focal length of the lens system at a wide-angle limit.

If the value goes below the lower limit of the condition (2), the image surface characteristic is deteriorated. If the value exceeds the upper limit of the condition (2), the effect of moving the principal point position to the image side is reduced, and a wider view angle of the lens system cannot be achieved. When the condition (2) is satisfied, an aperture diaphragm can be arranged on the object side relative to the principal point of the lens by allocating a strong positive optical power on the image side of the aperture diaphragm. Further, stray light can be reduced and the light blocking effect of the protection member can be increased by arranging a lens element having positive optical power on the image side relative to the mount surface.

The lens system of the present invention preferably satisfies the following condition.

0.11<f_{W}/D<1.5 (3)

where

f_{W} is a focal length of the lens system at a wide-angle limit, and

D is a diagonal length of the image sensor.

If the value goes below the lower limit of the condition (3), the optical power of the lens system is increased, and the number of lens elements should be increased to suppress aberration. If the value exceeds the upper limit of the condition (3), the view angle is narrowed, and an obtained image becomes hard to use.

### Embodiment 5

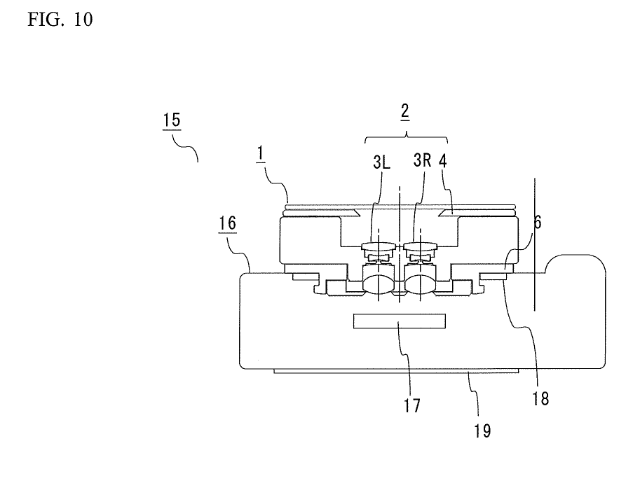

FIG. 10 is a schematic diagram of an interchangeable-lens type digital camera system according to Embodiment 5, which is viewed from above the camera body.

The interchangeable-lens type digital camera system 15 according to Embodiment 5 (referred to simply as camera system, hereinafter) includes a camera body 16, and an interchangeable lens apparatus 1 which is detachably connected to the camera body 16.

The camera body 16 includes: an image sensor 17 which receives optical images formed by the lens systems 3R and 3L of the interchangeable lens apparatus 1, and converts the optical images into electric image signals; a liquid crystal monitor 19 which displays the image signals obtained by the image sensor 17; and a camera mount section 18.

On the other hand, the interchangeable lens apparatus 1 includes lens systems 3R and 3L according to any of Embodiments 1 to 4, a field diaphragm 4, and a lens mount section 6 connected to the camera mount section 18 of the camera body. The camera mount section 18 and the lens mount section 6 are connected to each other not only physically but also electrically, and function as interfaces for electrically connecting a controller (not shown) inside the camera body 16 to a controller (not shown) inside the interchangeable lens apparatus 1, thereby achieving mutual signal communication.

In the interchangeable lens apparatus 1 of the present invention, interference between images formed by the pair of lens systems 3R and 3R and entry of stray light can be prevented by the field diaphragm 4 arranged at the front surface, without using a structure such as a partition. Therefore, as in the present embodiment, a combination of the interchangeable-lens type camera body and the interchangeable lens apparatus 1 can easily take a three-dimensional image.

### Examples

Numerical examples are described below, in which the lens systems according to Embodiments 1 to 4 are implemented. Numerical Examples 1 to 4 correspond to the configurations of Embodiments 1 to 4, respectively. In each numerical example, the units of length in the tables are all mm, and the units of view angle are all °. Moreover, in each numerical example, r is the radius of curvature, d is the axial distance, nd is the refractive index to the d-line, and vd is the Abbe number to the d-line. In each numerical example, the surfaces marked with * are aspheric surfaces, and the aspheric surface configuration is defined by the following formula.

$$Z = \frac{{h}^{2} / r}{1 + \sqrt{1 - ( 1 + κ ) {( h / r )}^{2}}} + \sum {A}_{n} {h}^{n}$$

Here, the symbols in the formula indicate the following quantities.

Z is the distance from a point on an aspheric surface at a height h relative to the optical axis to a tangential plane at the vertex of the aspheric surface,

h is the height relative to the optical axis,

r is the radius of curvature at the top,

κ is the conic constant, and

An is the n-th order aspheric coefficient.

Longitudinal aberration diagrams of the lens systems according to Numerical Examples 1 to 4 are shown in sections (b) of FIGS. 6 to 9, respectively. Each of sections (b) of FIGS. 6 to 9 shows, in order from the left-hand side, the spherical aberration (SA (mm)), the astigmatism (AST (mm)), and the distortion (DIS (%)). In each spherical aberration diagram, the horizontal axis indicates the defocus amount, the vertical axis indicates the F-number (in each diagram, indicated as F), and the solid line, the short dash line, and the long dash line indicate the characteristics to the d-line, the F-line, and the C-line, respectively. In each astigmatism diagram, the horizontal axis indicates the defocus amount, the vertical axis indicates the image height (in each diagram, indicated as H), and the solid line and the dash line indicate the characteristics to the sagittal image plane (in each diagram, indicated as s) and the meridional image plane (in each diagram, indicated as m), respectively. In each distortion diagram, the horizontal axis indicates the distortion, and the vertical axis indicates the image height (in each Fig., indicated as H).

(Numerical Example 1)
Surface data

| Surface number | r | d | nd | vd |
|---|---|---|---|---|
| Object surface | ∞ | | | |
| 1* | 24.16800 | 2.00000 | 1.72916 | 54.7 |
| 2 | −44.28300 | 0.74800 | | |
| 3 | −35.66200 | 0.80000 | 1.48749 | 70.4 |
| 4 | 5.00000 | 5.80300 | | |
| 5(Diaphragm) | ∞ | 0.40000 | | |
| 6 | 18.39700 | 5.80200 | 1.84666 | 23.8 |
| 7 | 6.11600 | 0.01000 | 1.56732 | 42.8 |
| 8 | 6.11600 | 4.50000 | 1.77250 | 49.6 |
| 9* | −8.79100 | 12.84100 | | |
| 10 | ∞ | BF | | |
| Image surface | ∞ | | | |

Aspherical data

| Surface No. | Parameters | | |
|---|---|---|---|
| 1 | K = 0.00000E+00, | A4 = −2.64660E−05, | A6 = −4.21465E−07 |
| 9 | K = −1.15010E+00, | A4 = 0.00000E+00, | A6 = 0.00000E+00 |

Various data

| | |
|---|---|
| Focal length | 10.0084 |
| F-number | 9.10188 |
| View angle | 27.4677 |
| Image height | 5.0000 |
| Overall length of lens system | 32.9137 |
| BF | 0.00970 |

(Numerical Example 2)
Surface data

| Surface number | r | d | nd | vd |
|---|---|---|---|---|
| Object surface | ∞ | | | |
| 1 | 8.90410 | 1.50000 | 1.84666 | 23.8 |
| 2 | −523.51880 | 1.06200 | | |
| 3 | −10.41960 | 0.80000 | 1.84666 | 23.8 |
| 4 | 5.00000 | 0.40000 | | |
| 5(Diaphragm) | ∞ | 0.40000 | | |
| 6 | 12.39620 | 4.42800 | 1.72916 | 54.7 |
| 7 | −5.73700 | 13.44000 | | |
| 8 | ∞ | BF | | |
| Image surface | ∞ | | | |

Various data

| | |
|---|---|
| Focal length | 13.0111 |
| F-number | 10.23062 |
| View angle | 22.7504 |
| Image height | 5.2330 |
| Overall length of lens system | 22.0300 |
| BF | 0.00000 |

(Numerical Example 3)
Surface data

| Surface number | r | d | nd | vd |
|---|---|---|---|---|
| Object surface | ∞ | | | |
| 1 | 15.36880 | 1.80000 | 1.71300 | 53.9 |
| 2 | −13.02980 | 0.63370 | | |
| 3 | ∞ | 0.00000 | | |
| 4 | −6.29790 | 0.80000 | 1.48749 | 70.4 |
| 5 | 5.00000 | 0.40000 | | |
| 6(Diaphragm) | ∞ | 0.40000 | | |
| 7 | 30.38940 | 3.37600 | 1.84666 | 23.8 |
| 8 | 5.65600 | 0.01000 | 1.56732 | 42.8 |
| 9 | 5.65600 | 4.50000 | 1.77250 | 49.6 |
| 10 | −6.63000 | 12.96920 | | |
| 11 | ∞ | BF | | |
| Image surface | ∞ | | | |

Various data

| | |
|---|---|
| Focal length | 12.0070 |
| F-number | 7.89480 |
| View angle | 24.4705 |
| Image height | 5.2330 |
| Overall length of lens system | 24.8889 |
| BF | 0.00000 |

(Numerical Example 4)
Surface data

| Surface number | r | d | nd | vd |
|---|---|---|---|---|
| Object surface | ∞ | | | |
| 1* | 24.58600 | 2.00000 | 1.72916 | 54.7 |
| 2 | 29.13400 | 1.48000 | | |
| 3 | 229.52100 | 3.00000 | 1.48749 | 70.4 |
| 4 | 5.00000 | 9.21500 | | |
| 5(Diaphragm) | ∞ | 0.40000 | | |
| 6 | 13.48000 | 7.03000 | 1.84666 | 23.8 |
| 7 | 5.00000 | 0.01000 | 1.56732 | 42.8 |
| 8 | 5.00000 | 4.50000 | 1.77250 | 49.6 |
| 9* | −9.02500 | 11.57200 | | |
| 10 | ∞ | BF | | |
| Image surface | ∞ | | | |

Aspherical data

| Surface No. | Parameters | | | |
|---|---|---|---|---|
| 1 | K = 0.00000E+00, | A4 = 6.49448E−05, | A6 = −5.79601E−08, | A8 = 2.45414E−09 |
| 9 | K = −1.62147E+00, | A4 = 0.00000E+00, | A6 = 0.00000E+00 | A8 = 0.00000E+00 |

Various data

| | |
|---|---|
| Focal length | 7.0076 |
| F-number | 8.87139 |
| View angle | 36.5642 |
| Image height | 5.0000 |
| Overall length of lens system | 39.2163 |
| BF | 0.00931 |

The following Table 1 shows the values corresponding to the respective conditions in the stereoscopic imaging optical systems (FIG. 4) configured by using the lens systems of the above-described Examples 1 to 4. In Table 1, the flange back is the distance (L in FIG. 4) from the mount surface of the lens mount section to the image sensor, and the stereo base is the distance (SB in FIG. 4) between the optical axes of the pair of lens systems

TABLE 1

| | Example 1 | Example 2 | Example 3 | Example 4 |
|---|---|---|---|---|
| (1) T/f_{W} | 0.35 | 1.54 | 0.53 | 3.57 |
| (2) fᵣₑₐᵣ/f_{W} | 0.97 | 2.27 | 0.69 | 1.35 |
| (3) f_{W}/D | 0.46 | 0.60 | 0.55 | 0.25 |
| 2ω | 54.9 | 45.5 | 48.9 | 73.1 |
| f_{W} | 10.0 | 13.0 | 12.0 | 7.0 |
| T | 3.5 | 20.0 | 6.3 | 25.0 |
| fᵣₑₐᵣ | 9.72 | 29.57 | 8.23 | 9.48 |
| D | 21.63 | 21.63 | 21.63 | 28.40 |
| Flange back | 20.0 | 20.0 | 20.0 | 18.0 |
| Stereo base | 10.0 | 10.0 | 10.0 | 14.0 |

The present invention is can be used as an optical system of an imaging device for taking a three-dimensional image.

While the invention has been described in detail, the foregoing description is in all aspects illustrative and not restrictive. It will be understood that numerous other modifications and variations can be devised without departing from the scope of the invention.

What is claimed is:

1. A stereoscopic imaging optical system for forming optical images of an object on first and second imaging areas, respectively, the stereoscopic imaging optical system comprising:
a first lens system for forming an optical image of the object on the first imaging area;
a second lens system for forming an optical image of the object on the second imaging area, the second lens system being arranged in parallel to the first lens system; and
a field diaphragm arranged on the object side relative to the first and second lens systems, wherein
the first and second lens systems are arranged in such a positional relation that an image circle formed by each of the first and second lens systems is overlapped with both the first and second imaging areas, and
the field diaphragm does not block a light beam which enters an area on the opposite side to the second imaging area with respect to the first imaging area, and a light beam which enters an area on the opposite side to the first imaging area with respect to the second imaging area, but blocks a light beam which enters the second imaging area from the first lens system, and a light beam which enters the first imaging area from the second lens system.

2. The stereoscopic imaging optical system according to claim 1, wherein
the field diaphragm is composed of a member having an aperture, and
a light beam which enters adjacent portions of the first and second imaging areas, is blocked by a pair of linear edge portions of a circumferential edge of the aperture, the edge portions being parallel to the imaging surfaces of the first and second imaging areas and extending in a direction perpendicular to a direction in which the first and second lens systems are arranged in parallel.

3. The stereoscopic imaging optical system according to claim 1, wherein
the light beam which enters the first lens system and the light beam which enters the second lens system are partially overlapped with each other on a plane including the field diaphragm.

4. The stereoscopic imaging optical system according to claim 1 satisfying the following condition:
0.1<T/f_{W}<15.0 (1)
where
T is a distance from a most object-side lens surface of each of the first and second lens systems to the field diaphragm, and
f_{W} is a focal length of each of the first and second lens systems at a wide-angle limit.

5. The stereoscopic imaging optical system according to claim 1, wherein a diagonal view angle at a wide-angle limit of each of the first and second lens systems is 35 degrees or greater.

6. An interchangeable lens apparatus which is detachably attached to a camera body equipped with an image sensor, the interchangeable lens apparatus comprising:
a stereoscopic imaging optical system according to claim 1; and
a lens mount section which is connectable to a camera mount section of the camera body.

7. The interchangeable lens apparatus according to claim 6, wherein
the lens mount section has a mount surface that contacts the camera mount section in a plane-to-plane manner, and
the first and second lens systems include lens elements that protrude from the mount surface toward the image side.

8. The interchangeable lens apparatus according to claim 7 further comprising a protection member for protecting the lens elements that protrude from the mount surface toward the image side.

9. The interchangeable lens apparatus according to claim 7 satisfying the following condition:
0.3<fᵣₑₐᵣ/f_{W}<2.8 (2)
where
fᵣₑₐᵣ is a synthetic power of the lens elements protruding from the mount surface toward the image side, and
f_{W} is a focal length of each of the first and second lens systems at a wide-angle limit.

10. The interchangeable lens apparatus according to claim 7, wherein the number of the lens elements that protrude from the mount surface toward the image side is four.

11. The interchangeable lens apparatus according to claim 6 satisfying the following condition:
0.11<f_{W}/D<1.5 (3)
where
f_{W} is a focal length of each of the first and second lens systems at a wide-angle limit, and
D is a diagonal length of the image sensor.

12. A camera system comprising:
an interchangeable lens apparatus including a stereoscopic imaging optical system according to claim 1; and
a camera body which is detachably connected to the interchangeable lens apparatus via a camera mount section, and includes an image sensor which receives an optical image formed by the stereoscopic imaging optical system and converts the optical image into an electric image signal.
